(19) United States
(12) Patent Application Publication
(10) Pub. No.: US 2026/0051141 A1
(43) Pub. Date: Feb. 19, 2026

(54) System and method for document anomaly detection along a network path of the document

(71) Applicant: Bank of America Corporation, Charlotte, NC (US)

(72) Inventors: George Albero, Charlotte, NC (US); Naga Vamsi Krishna Akkapeddi, Charlotte, NC (US); Saurabh Arora, Gurugram (IN)

(21) Appl. No.: 18/808,155

(22) Filed: Aug. 19, 2024

(51) Int. Cl. G06V 10/30; H04L 9/08

(52) U.S. Cl. CPC G06V 10/30; H04L 9/0819

(57) ABSTRACT

A system for document anomaly detection along a network path of a document is disclosed. The system receives a first document data that is generated based on a first processing operation on the document at a first computing device. The system generates a first image for the first document data. The first image uniquely identifies the first document data. The system encrypts the first image with a first noise filter. The system receives a second document data that is generated based on a second processing operation on the document at a second computing device. The system determines that the second document data is anomalous. In response, the system performs the second processing operation on the document.

### TECHNICAL FIELD

The present disclosure relates generally to network security, and more specifically to a system and method for document anomaly detection along a network path of the document.

### BACKGROUND

Documents traverse along multiple computing devices in a network to be processed. A different operation may be performed on a document at each computing device.

### SUMMARY

The disclosed system, described in the present disclosure, is particularly integrated into a practical application of improving document error detection and mitigation techniques. This practical application provides several technical advantages, including conserving computational and network resources that would otherwise be used to process and communicate erroneous and corrupted documents.

In some cases, a document may travel along a network path among different computing devices so that specific operations can be performed on the document at the computing devices, respectively. For example, at each computing device, the document may be fed to a software application so that certain operations can be performed on the document via the software application, respectively. In some occasions, document data may be lost either partially or in full due to various reasons, such as incorrect code, incorrect error handling procedures in place at a given computing device, network congestion causing buffer overflows at a given computing device, or improper reprocessing techniques. The problem arises when an operation on a computing device is not performed correctly due to the various reasons mentioned above. If an error occurs at any stage, the document processing is halted and the document processing is restarted from the beginning. If such an error is not detected, it leads to incomplete or corrupted document data which leads to further failures in the downstream computing devices.

The disclosed system is configured to provide a technical solution to these and other problems in the realm of document error handling in a network. In some embodiments, the system is configured to implement a checkpoint recovery technique where the document data is evaluated at each checkpoint—e.g., each computing device to determine whether or not the processing operation on the document data is completed. If it is determined that a processing operation on the document data is not completed, the system may determine that the reason for the failed operation is any or a number of incorrect codes, incorrect error handling procedures in place at a given computing device, network congestion causing buffer overflows at a given computing device, or improper reprocessing techniques. In response, the system may perform certain actions to mitigate the erroneous processing operation.

In some embodiments, the system is configured to generate an image for each document data, infuse noise into the image, and store the noise-infused image in the database. As the document travels through different computing devices, the applications on these computing devices capture the document data via monitoring traces. For example, each document data may include a document identifier (ID), application programming interface (API) name, user name, address, document checkpoint, and the content of the document in an encrypted format. This information may be used to index/label the respective image with the document data, respectively. If it is determined that a processing operation has not been completed, the system may implement a checkpoint recovery method in which the last safe (uncorrupted) state of the document data before the processing operation failed is identified, the image associated with the last safe (uncorrupted) state of the document data is recovered from the database, and the processing operation is re-executed on the last safe (uncorrupted) document data.

In this way, the disclosed system improves the error detection and mitigation techniques. By implementing the checkpoint recovery method, the system automatically detects anomalies along the document network path and reconstructs the document data from the point where it was lost/corrupted. This, in turn, leads to document processing continuing without manual intervention, which improves the reliability and efficiency of document error handling systems.

Furthermore, by implementing the disclosed document error handling system, computational and network resources that would otherwise be spent on handling corrupted document data are conserved. For example, by detecting and mitigating an error in processing the document along its network path, the document processing does not need to restart from the beginning. In another example, by detecting and mitigating an error in processing the document along its network path, the corrupted/erroneous document data does not propagate to the downstream devices. Thus, the computational and network resources for transmitting and processing the corrupted/erroneous document are preserved in the downstream devices.

In some embodiments, a system for document anomaly detection along a network path of a document comprises a memory operably coupled with a processor. The memory is configured to store a document. The processor is configured to receive first document data from a first computing device, wherein the first document data is generated based at least in part upon a first processing operation on the document at the first computing device. The processor is further configured to generate a first image for the first document data, wherein the first image uniquely identifies the first document data. The processor is further configured to encrypt the first image with a first noise filter, wherein the first noise filter acts as a first encryption key for the first image. The processor is further configured to store the encrypted first image in a database. The processor is further configured to receive second document data from a second computing device, wherein the second document data is generated based at least in part upon a second processing operation on the document at a second computing device. The processor is further configured to determine that the second document data is anomalous, wherein determining that the second document data is anomalous comprises determining that the second processing operation failed to complete. The processor is further configured to perform the second processing operation on the document in response to determining that the second document data is anomalous.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system for document anomaly detection and mitigation along a network path of a document;

FIG. 2 illustrates an example operational flow of the system of FIG. 1; and

FIG. 3 illustrates an example flow chart of a method of the system of FIG. 1;

### DETAILED DESCRIPTION

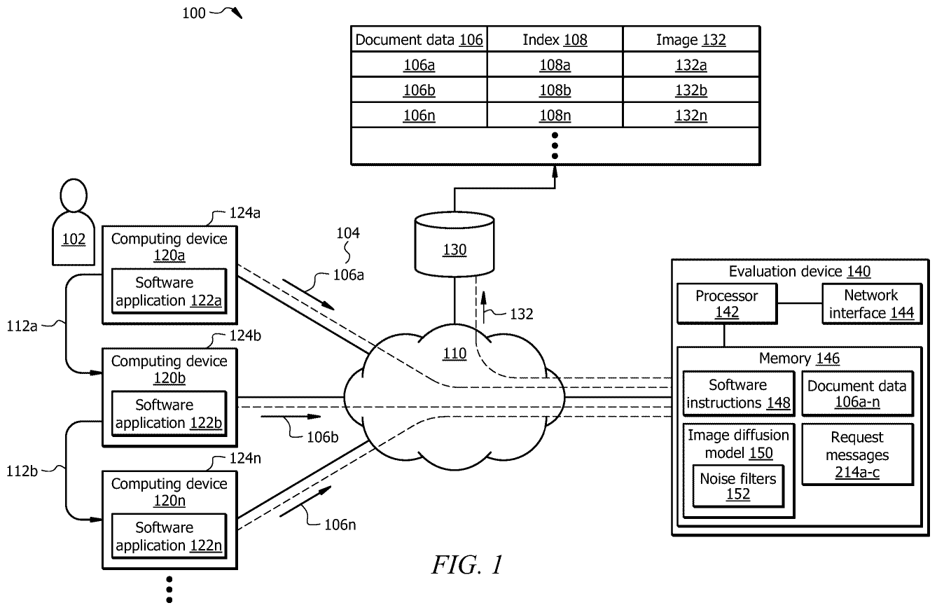

As described above, previous technologies fail to provide efficient and reliable solutions for document anomaly detection and mitigation along a network path of a document. Embodiments of the present disclosure and its advantages may be understood by referring to FIGS. 1 through 3. FIGS. 1 through 3 are used to describe systems and methods for document anomaly detection and mitigation along a network path of a document, according to some embodiments.

### System Overview

FIG. 1 illustrates an embodiment of a system 100 that is generally configured to detect and mitigate document anomalies that may occur along a network path of a document in a network. In some embodiments, the system 100 may comprise an evaluation device 140 communicatively coupled with one or more computing devices 120a-n and database 130, via a network 110. The network 110 enables communication among the components of the system 100. A document 104 may travel through one or more hops 112a-n among the computing devices 120a-n, for example, to be processed and certain processing operations 124a-n to be performed on the document 104. The database 130 may store information that may be used by other components of the system 100. The evaluation device 140 may be configured to evaluate document data 106 at every stage/computing device 120a-n to determine whether the document data 106 is anomalous. If it is determined that document data 106 is anomalous at a certain computing device 120a-n, the evaluation device 140 may perform certain actions to address and mitigate the anomalous document data 106. In other embodiments, system 100 may include other elements instead of, or in addition to, those listed above.

In general, the system 100 improves the document anomaly detection and mitigation techniques. In some cases, a document 104 may travel along a network path among different computing devices 120a-n so that specific operations 124a-c to be performed on the document 104 at the computing devices 120a-n, respectively. For example, at each computing device 120a-n, the document 104 may be fed to a software application 122a-n so that certain operations 124a-c to be performed on the document 104 via the software application 122a-n, respectively. In some occasions, document data 106 may be lost either partially or in full due to various reasons, such as incorrect code, incorrect error handling procedure in place at a given computing device 120, network congestion causing buffer overflows at a given computing device 120, or improper reprocessing techniques. The problem arises when an operation 124a-c at a computing device 120a-n is not performed correctly due to the various reasons mentioned above. If an error occurs at any stage, the document processing is halted and the document processing is restarted from the beginning. If such an error is not detected, it leads to an incomplete or corrupted document data 106 which leads to further failures in the downstream computing devices.

In some embodiments, the system 100 is configured to implement a checkpoint recovery technique where the document data 106 is evaluated at each checkpoint—e.g., each computing device 120a-n to determine whether the processing operation 124 on the document data 106 is completed or not. If it is determined that a processing operation 124 on the document data 106 is not completed, the system 100 may determine that the reason for the failed operation is any or a number of incorrect codes, incorrect error handling procedures in place at a given computing device 120, network congestion causing buffer overflows at a given computing device 120, or improper reprocessing techniques. In response, the system 100 may perform certain actions to mitigate the erroneous processing operation 124.

In some embodiments, the system 100 is configured to generate an image 132a-n for each document data 106a-n, infuse noise into the image 132a-n, and store the noise-infused image 132a-n in the database 130. As the document 104 travels through different computing devices 120a-n, the applications 122a-n on these computing devices 120a-n capture the document data 106a-n via monitoring traces. For example, each document data 106a-n may include a document identifier (ID), application programming interface (API) name, user name, address, document checkpoint, and the content of the document in an encrypted format. This information may be used to index/label the respective image 132a-n with the document data 106a-n, respectively. If it is determined that a processing operation 124 has not been completed, the system 100 may implement a checkpoint recovery method in which the last safe (uncorrupted) state of the document data 106 before the processing operation 124 failed is identified, the image 132 associated with the last safe (uncorrupted) state of the document data 106 is recovered from the database 130, and the processing operation 124 is re-executed on the last safe (uncorrupted) document data 106.

In this way, the disclosed system 100 improves the error detection and mitigation techniques. By implementing a checkpoint recovery method, the system 100 automatically detects anomalies along the document network path and reconstructs the document data 106 from the point where it was lost/corrupted. This, in turn, leads to the document processing to continue without manual intervention, which improves the reliability and efficiency of document error handling systems.

Furthermore, by implementing the disclosed document error handling system 100, computational and network resources that would otherwise be spent on handling and processing corrupted document data are conserved. For example, by detecting and mitigating an error in processing the document 104 along its network path, the document processing does not need to restart from the beginning. In another example, by detecting and mitigating an error in processing the document 104 along its network path, the corrupted/erroneous document data 106 does not propagate to the downstream devices. Thus, the computational and network resources for transmitting and processing the corrupted/erroneous document 104 are preserved in the downstream devices.

### SYSTEM COMPONENTS

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wi-Fi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may be configured to support any suitable type of communication protocol, as would be appreciated by one of ordinary skills in the art.

### Example Computing Device

Each of the computing devices 120a-n is an instance of a computing device 120. The computing device 120 may generally be any device that is configured to process data and interact with users 102. Examples of the computing device 120 include, but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The computing device 120 may include a user interface, such as a display, a microphone, a camera, a keypad, or other appropriate terminal equipment usable by user 102.

The computing device 120 may include a hardware processor, memory, and/or circuitry configured to perform any of the functions or actions of the computing device 120 described herein. For example, the computing device 120 includes a processor in signal communication with a network interface and a memory. The memory stores software instructions (e.g., code) that, when executed by the processor, cause the processor to perform one or more operations of the computing device 120 described herein. The user 102 may use the computing device 120a to initiate the communication of the document 104 and document data 106a to other devices 120.

The document 104 may processed at each computing device 120a-n along its network path. In some examples, the document 104 may include one or more files, source code, a document containing text, a filled-out form, a transaction, among others. In some examples, each of the processing operations 124a-n may include validating user credentials, validating the integrity of the document, performing data transformations (e.g., data normalization, data encryption, data parsing, data format conversion, data schema conversion, etc.), performing a query on the document 104, verifying the accuracy of the information contained in the document 104, among others.

The computing device 120a may store the software application 122a. The computing device 120a may be configured to perform the processing operation 124a on the document 104 via the software application 122a. For example, the document 104 may be fed to the software application 122a and the software application 122a may perform the processing operation 124a on the document 104. When the processing operation 124a is performed on the document 104, the computing device 120a may capture the document data 106a. The document data 106a may include document ID, API name (associated with the API request/call that performs the processing operation 124a), user name, address, document checkpoint (e.g., indicating the computing device 120a), and the current content of the document in an encrypted format.

In some embodiments, the computing device 120a may communicate the document data 106a and document 104 to the evaluation device 140 for generating an image 132a, among other operations. The computing device 120a may communicate the document data 106a (representing a first stage of processing the document 104) to the computing device 120b via a first hop 112a. Similar operations may be performed at the computing device 120b.

The computing device 120b may store the software application 122b. The computing device 120b may be configured to perform the processing operation 124b on the document 104 and/or document data 106a via the software application 122b. For example, the document 104 and/or document data 106a may be fed to the software application 122b and the software application 122b may perform the processing operation 124b on the document 104 and/or document data 106a. When the processing operation 124b is performed on the document 104 and/or document data 106a, the computing device 120b may capture the document data 106b. The document data 106b may include document ID, API name (associated with the API request/call that performs the processing operation 124b), user name, address, document checkpoint (e.g., indicating the computing device 120b), and the current content of the document in an encrypted format.

The computing device 120b communicates the document data 106b (representing a second stage of processing the document 104) to the evaluation device 140 for generating an image 132b, among other operations. The computing device 120b may communicate the document data 106b to the next computing device 120n along the network path of the document processing via a second hop 112b. Similar operations may be performed at the computing device 120n.

The computing device 120n may store the software application 122n. The computing device 120n may be configured to perform the processing operation 124n on the document 104/document data 106b via the software application 122n. For example, the document 104/document data 106b may be fed to the software application 122n and the software application 122n may perform the processing operation 124n on the document 104 and/or document data 106b. When the processing operation 124n is performed on the document 104 and/or document data 106b, the computing device 120n may capture the document data 106n. The document data 106n may include document ID, API name (associated with the API request/call that performs the processing operation 124n), user name, address, document checkpoint (e.g., indicating the computing device 120n), and the current content of the document in an encrypted format. The computing device 120n communicates the document data 106n (representing a third stage of processing the document 104) to the evaluation device 140 for generating an image 132n, among other operations.

In this way, each stage of the document processing path is monitored and the document data 106 is evaluated. Thus, any potential error or anomaly is detected and mitigated. In some embodiments, the evaluation device 140 may act as a gateway device and/or monitoring device that obtains (e.g., receives or intercepts) the document 104 and document data 106a-c for evaluation.

### Database

The database 130 generally comprises any storage architecture. Examples of the database 130, include, but are not limited to, a network-attached storage cloud, a storage area network, a data lake, a data warehouse, and a storage assembly directly (or indirectly) coupled to one or more components of the system 100. The database 130 may store images 132a-n. Each image 132a-n may be labeled with document data 106a-n and indexes 108a-n, respectively.

Each index 108a-n may include specific metadata with respect to the respective document data 106a-n, such as the document ID, API name (associated with the API request/call that performs the processing operation 124), user name, address, document checkpoint (e.g., indicating the computing device 120), and the respective content of the document 104 at a given stage of processing. Each index 108a-n may be used to identify and retrieve the corresponding document data 106 and associated images 132 from the database 130.

### Evaluation Device

The evaluation device 140 may include one or more hardware computer systems, such as workstations, virtual machines, etc. For example, the evaluation device 140 may be implemented by a plurality of computing devices using distributed computing and/or cloud computing systems in a network. In some embodiments, the evaluation device 140 may be one or more servers in a server farm. In some embodiments, the evaluation device 140 may include one or more servers in one or more data centers, data warehouses, and the like. The evaluation device 140 may be an instance of one or more servers. In certain embodiments, the evaluation device 140 may be configured to provide services and resources (e.g., data and/or hardware resources) to the components of the system 100. The evaluation device 140 may generate an image 132a-n for document data 106a-n, respectively, infuse each image 132a-n with a specific noise pattern, label/associate each image 132a-n with respective indexes 108a-n and document data 106a-n, respectively, and in case of an erroneous or anomalous document data 106a-n, use the index 108 to identify the image 132a-n associated with the last safe (uncorrupted) document data 106a-n, respectively, recover the last safe uncorrupted document data 106a-n, and re-execute the processing operation 124a-n that initially failed and led to erroneous or anomalous document data 106a-n, respectively.

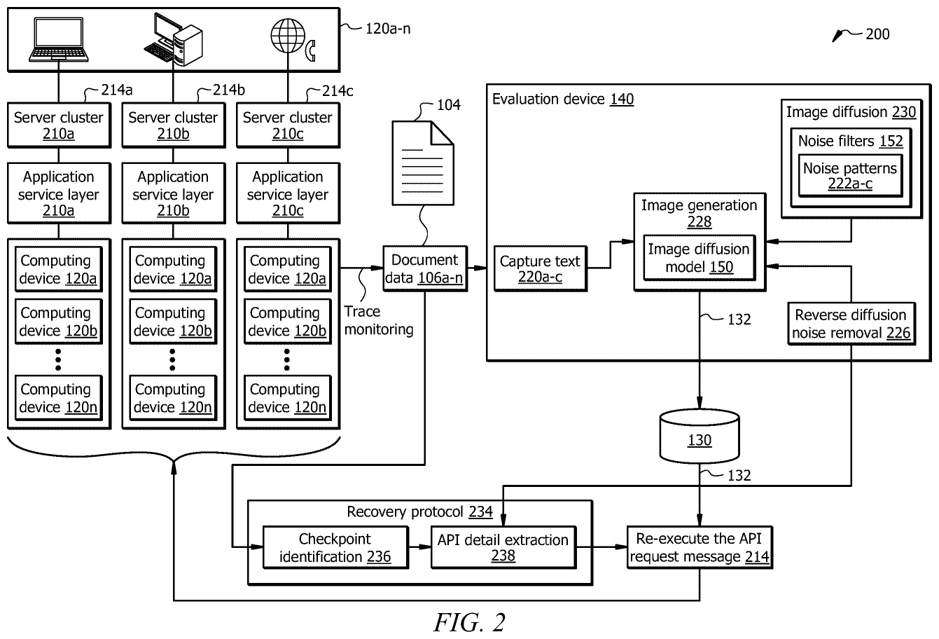

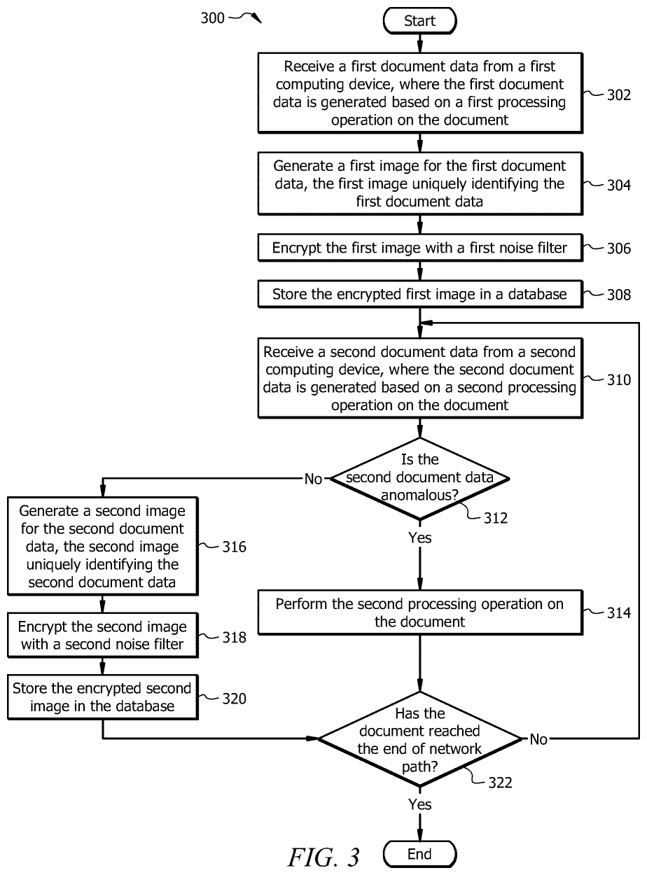

The evaluation device 140 comprises a processor 142 operably coupled with a network interface 144 and a memory 146. Processor 142 comprises one or more processors. The processor 142 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). For example, one or more processors may be implemented in cloud devices, servers, virtual machines, and the like. The processor 142 may be a programmable logic device, a microcontroller, a microprocessor, or any suitable number and combination of the preceding. The one or more processors are configured to process data and may be implemented in hardware or software. For example, the processor 142 may be 8-bit, 16-bit, 32-bit, 64-bit, or of any other suitable architecture. The processor 142 may include an arithmetic logic unit (ALU) for performing arithmetic and logic operations. The processor 142 may register the supply operands to the ALU and store the results of ALU operations. The processor 142 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the evaluation device 140 described herein. In this way, processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-3. For example, the processor 142 may be configured to perform one or more operations of the operational flow 200 described in FIG. 2, and one or more operations of the method 300 as described in FIG. 3.

Network interface 144 is configured to enable wired and/or wireless communications. The network interface 144 may be configured to communicate data between the evaluation device 140 and other devices, systems, or domains of the system 100. For example, the network interface 144 may comprise a near-field communication (NFC) interface, a Bluetooth interface, a Zigbee interface, a Z-Wave interface, a radio-frequency identification (RFID) interface, a Wi-Fi interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 142 may be configured to send and receive data using the network interface 144. The network interface 144 may be configured to use any suitable type of communication protocol.

The memory 146 may be a non-transitory computer-readable medium. The memory 146 may be volatile or non-volatile and may comprise read-only memory (ROM), random-access memory (RAM), ternary content-addressable memory (TCAM), dynamic random-access memory (DRAM), and static random-access memory (SRAM). The memory 146 may include one or more of a local database, cloud database, network-attached storage (NAS), etc. The memory 146 comprises one or more disks, tape drives, or solid-state drives, and may be used as an over-flow data storage device, to store programs when such programs are selected for execution, and to store instructions and data that are read during program execution. The memory 146 may store any of the information described in FIGS. 1-3 along with any other data, instructions, logic, rules, or code operable to implement the function(s) described herein when executed by processor 142. For example, the memory 146 may store software instructions 148, image diffusion model 150, noise filters 152, document data 106a-n, request messages 214a-c, and/or any other data or instructions. The software instructions 148 may comprise any suitable set of instructions, logic, rules, or code operable to execute the processor 142 and perform the functions described herein, such as some or all of those described in FIGS. 1-3.

The image diffusion model 150 may be implemented by the processor 142 executing the software instructions 148 and is generally configured to generate images 132a-n, and label each image 132a-n with document data 106a-n and indexes 108a-n, respectively. The image diffusion model 150 may comprise a support vector machine, neural network, random forest, k-means clustering, etc. The image diffusion model 150 may be implemented by a plurality of neural network (NN) layers, convolutional NN (CNN) layers, long-short-term-memory (LSTM) layers, Bi-directional LSTM layers, recurrent NN (RNN) layers, and the like. In some examples, the image diffusion model 150 may be implemented by image processing, natural language processing (NLP), data processing, text recognition, text-to-image generating algorithm, etc.

The image diffusion model 150 may be given document data 106 (any of document data 106a-n) and is asked to generate an image 132 (any of images 132a-n) for the document data 106. In this process, in some embodiments, the image diffusion model 150 may generate a random image 132 based on a preconfigured instruction to generate a random image for document data 106. In some embodiments, the image diffusion model 150 may generate an image 132 by a text-to-image generating algorithm, in which the document data 106 is converted into a visual representation. The text-to-image generating algorithm interprets the content of the document data 106 and creates an initial image that visually captures the key information and structure of the document data 106 (e.g., indexes 108), such as document ID, API name (associated with the API request/call that performs the processing operation 124), user name, address, document checkpoint (e.g., indicating the computing device 120), and the content of the document 104. In this process, for example, the image diffusion model 150 may determine the color value of each pixel of the image 132 such that the overall image 132 is a coherent image 132.

In response to generating image 132, the image diffusion model 150 may add a noise pattern to the image 132, for example, by applying a noise filter 152 to the image 132. In some embodiments, the image diffusion model 150, in a forward diffusion process, may progressively add noise to the image 132 over several stages. The noise filter 152 may be configured with one or more specific noise patterns. The noise filter 152 may act as an encryption key to encrypt the image 132. The evaluation device 140 may store the noise-infused images 132 in the database 130. When the original image 132 is needed, the image diffusion model 150 may reverse the noise diffusion process to remove the added noise pattern and output the original image 132. In this process, the image diffusion model 150, in a reverse diffusion process, may remove the noise step-by-step to recover the original image 132.

### Operational Flow for Document Anomaly Detection and Mitigation

FIG. 2 illustrates an example operational flow 200 of the system 100 (see FIG. 1) for document anomaly detection and mitigation along the network path of the document 104, according to certain embodiments. In certain embodiments, the document processing of the document 104 may be initiated from different types of computing devices 120a-n. For example, the document 104 may be initiated from a desktop computer, a laptop, a mobile phone, an IVR device, among others. In response, the document 104 is directed to the appropriate server cluster 210a-c based on the type of request and the originating device. These clusters handle different categories of application requests. For example, for desktop application request messages 214a, the document 104 is processed in server cluster 210a. The server cluster 210a includes application service layer 212a, which consists of request messages 214a triggered by user interactions from desktop applications 122. When a user clicks a process button on the desktop application 122, a request message 214a is made to initiate the processing operation 124a on the document 104.

In some embodiments, the system 100 of FIG. 1 may include the server clusters 210a-c. Each server cluster 210a-c may be an instance of a server cluster 210. Each server cluster 210a-c may include one or more computing devices 120a-n and application service layer 212a-n, respectively. Each application service layer 212a-c may act as an interface (e.g., a user interface, a network interface) for the computing devices 120a-c, respectively.

Within server cluster 210a, multiple computing devices 120a-n may process the document 104. Similarly, for request messages 214b-c originating from other types of computing devices 120, such as laptops or IVR devices, the document 104 is processed in the corresponding server clusters 210b-c, respectively. Each cluster 120b-c includes its application service layer (e.g., application service layer 212b for server cluster 210b and application service layer 212c for server cluster 210c) and multiple computing devices 120 (e.g., computing device 120a-n within each server cluster 210b-c) to handle the document processing, respectively. In some embodiments, different computing devices 120 may be included in each server cluster 210a-n. In some embodiments, at least some computing devices 120 may overlap among the server clusters 210a-n.

The operational flow 200 may be performed at each stage/computing device 120a-n for any of the request messages 214a-c to execute the processing operations 124a-c, respectively. In operation, the before, during, and/or after processing operation 124a-c is performed on the document data 106 and/or document 104, the document data 106 may be evaluated by the evaluation device 140. In the example of FIG. 2, assume that the processing operation 124 is performed on the document 104 and/or document data 106 by any of the computing devices 120a-c. In response, the document data 106 may be communicated to the evaluation device 140 for processing and evaluation.

### Generating an Image for Document Data

The evaluation device 140 may receive the document data 106 (e.g., any of the document data 106a-c) from the computing device 120 (e.g., any of the computing devices 120a-c). The document data 106 may be generated based on the processing operation 124 on document 104 at the computing device 120. For example, the document data 106 may include text such as code, user information, timestamps, and any modifications made to the document content during processing operation 124. The evaluation device 140 uses trace monitoring processes to capture detailed traces of the document data 106 as it passes through the various stages of processing. These traces include information such as the document ID, API name, user name, address, document checkpoint, and the content of the document in an encrypted format.

The evaluation device 140 may capture the content of the document data 106. In this process, the evaluation device 140 may parse the document data 106 using a text parsing and recognition algorithm to capture the content of the document data 106. The content of document data 106 may include text 220. In response, the evaluation device 140 may capture index 108 associated with the document data 106.

The evaluation device 140 may generate an image 132 for the document data 106 in the image generation process 228. The image 132 may uniquely identify the document data 106. In this process, the evaluation device 140 may feed the document data 106 and the captured text 220 to the image diffusion model 150. The image diffusion model 150 may implement a text-to-image generating algorithm to generate the image 132 for the document data 106. In some embodiments, the image 132 may be a random image, similar to that described in FIG. 1. In some embodiments, the image 132 may be based on the content of the document data 106, similar to that described in FIG. 1.

In response to generating the image 132, the evaluation device 140 may label or associate the image 132 with the respective document data 106 and the index 108. The indexes 108 may include information that may be used to identify and trace the document data 106, such as document ID, API name (associated with the API request/call that performs the processing operation 124), user name, address, document checkpoint (e.g., indicating the computing device 120), and the content of the document 104.

The evaluation device 140 (e.g., via the image diffusion model 150) may encrypt the generated image 132 in the image diffusion process 230. For example, in some embodiments, the image diffusion model 150 may encrypt the generated image 132 with a noise filter 152 that is configured to add or infuse the image 132 with a particular noise pattern 222 in the forward diffusion process described in FIG. 1. In this operation, the image diffusion model 150 may apply a noise filter 152 that overlays the image 132 with a specific noise pattern 222. The noise filter 152 may generate a specific, random, or pseudo-random noise pattern 222 using a noise-generating algorithm, such as the Gaussian noise-generating algorithm. The generated noise pattern 222 may be superimposed onto the image 132 by adjusting the pixel values of the image 132 according to the noise pattern 222.

In some embodiments, encrypting the image 132a-c with a respective noise filter 152 (and respective noise pattern 222a-c) may include performing a noise-inducing operation on the image 132a-c, where performing the noise-inducing operation on the image 132a-c includes changing pixel values associated with the image 132a-c according to a preconfigured noise pattern 222a-c.

In some embodiments, the intensity and distribution of the noise pattern 222 may be consistent across the pixels of the image 132 such that the original image 132 is unrecognizable from the noised-induced image 132. In some embodiments, the intensity and distribution of the noise pattern 222 may be consistent across the pixels of the image 132 such that the original image 132 is at least partially unrecognizable from the noise-induced image 132.

In some embodiments, the noise pattern 222a-c may be unique for each image 132a-c, respectively. For example, the noise filter 152 may be instructed to generate a customized noise pattern per image 132a-c. In some embodiments, the noise filter 152 and/or the noise pattern 222 may act as an encryption key for the image 132. In this way, the image 132 is secured even upon unauthorized access and without having the appropriate mechanisms to reverse the noise pattern 222. The evaluation device 140 may store the noise-induced image 132 labeled with the respective document data 106 and indexes 108 in the database 130.

Similar operations may be performed for any document data 106a-c. For example, with respect to the document data 106a-c, the evaluation device 140 may receive the document data 106a-c from the first computing device 120a-c, respectively, where the document data 106a-c is generated based on the processing operation 124ac-c on the document 104 and/or preceding document data 106 at the computing device 120a-c via the software application 122a-c and executing the request message 214a-c, respectively.

The evaluation device 140 may capture the text 220a-c of each document data 106a-c, generate an image 132a-c for the respective document data 106a-c, infuse a respective noise pattern 22a-c onto the image 132a-c, and store the noise-induced image 132a-c associated with the respective document data 106a-c and indexes 108a-c in the database 130. The evaluation device 140 may use this information to mitigate a failed processing operation 124 on a particular document data 106a-c.

### Detecting an Anomalous Document Data

In the example scenario, assume that the second processing operation 124b is anomalous due to incorrect code for performing the second processing operation 124, incorrect error handling procedure in place at the computing device 120b, network congestion causing buffer overflows at the computing device 120b, or improper reprocessing techniques, similar to that described in FIG. 1.

The evaluation device 140 may receive the second document data 106b from the second computing device 120b, where the second document data 106b is generated based on the second processing operation 124b on the document 104 (and/or the document data 106a) at the second computing device 120b via the software application 122b and executing the request message 214b to perform the processing operation 124b on the document 104 and/or the document data 106a. In response, the evaluation device 140 may capture the context of the document data 106b, where the context may include the text 220b indicated in the document data 106b.

The evaluation device 140 may evaluate the document data 106b to determine whether it is anomalous. In some embodiments, the evaluation device 140 may determine that the document data 106b is anomalous if it is determined that the processing operation 124b failed to complete. For example, the evaluation device 140 may determine that the processing operation 124b failed to complete by detecting that the document data 106b is missing an expected data, e.g., based on the expected content and data format/schema of the document data 106b. For example, the document data 106 may be missing an expected field, value, and text, among others.

In some embodiments, the evaluation device 140 may determine that the document data 106b is anomalous in response to identifying inconsistencies in the document data 106b, such as mismatched information or corrupted data segments that do not align with the known processing patterns based on analysis of historical document data 106.

In some embodiments, the evaluation device 140 may determine that the document data 106b is anomalous based on comparing the image 132b (associated with the document data 106b) with the image 132a (associated with the document data 106a). To this end, the evaluation device 140 may generate the image 132b for the document data 106b, where the image 132b uniquely identifies the document data 106b. The evaluation device 140 may encrypt the image 132b with a second noise filter 152 by implementing a second noise pattern 222b. The second noise filter 152 and the noise pattern 222b may act as an encryption key for the image 132b. The evaluation device 140 may store the image 132b in the database 130, similar to that described above.

To compare the image 132b with the image 132a, the evaluation device 140 may decrypt the encrypted (noise-induced) image 132a by removing the first noise pattern 222a from the image 132a, where the first noise pattern 222a is added to the image 132a by the first noise filter 152, similar to that described above. In this process, the evaluation device 140 may perform the reverse diffusion-noise removal operation 226 on the image 132a. In the reverse diffusion-noise removal operation 226, the evaluation device 140 removes the first noise pattern 222a from the image 132a by removing the alternation to the pixel values of the image 132a that was applied during the initial noise infusion process. In this way, the original image 132a is restored.

The evaluation device 140 may identify and extract the first document data 106a based on the decrypted first image 132a. The evaluation device 140 may perform similar operations for the second image 132b if it is encrypted. In this process, the evaluation device 140 may decrypt the encrypted (noise-induced) image 132b by removing the second noise pattern 222b from the image 132b, where the second noise pattern 222b is added to the image 132b by the second noise filter 152, similar to that described above. In this process, the evaluation device 140 may perform the reverse diffusion-noise removal operation 226 on the image 132b. In reverse diffusion-noise removal operation 226, the evaluation device 140 removes the second noise pattern 222b from the image 132b by removing the alternation to the pixel values of the image 132b that was applied during the initial noise infusion process. In this way, the original image 132b is restored. The evaluation device 140 may identify and extract the second document data 106b based on the decrypted second image 132b.

If the image 132b is not encrypted yet, the evaluation device 140 may not need to decrypt the image 132b for the comparison described above. The evaluation device 140 may compare the document data 106a with the document data 106b. In this process, the evaluation device 140 may extract text 220a from the document data 106a and extract the text 220b from the document data 106b. The evaluation device 140 may compare each text 220a of the document data 106a with the counterpart text 220b of the document data 106b. In some embodiments, if the evaluation device 140 determines that the second document data 106b is missing certain data that is present in the first document data 106b, the evaluation device 140 may determine that the second document data 106b is anomalous or erroneous.

In some embodiments, the evaluation device 140 may analyze metadata associated with each of the document data 106a-b, where the metadata may include processing logs, timestamps, document version, and modifications made to each document data. If any discrepancy is detected between the metadata associated with the document data 106a-b, the evaluation device 140 may determine that the document data 106b is anomalous. Such discrepancy may include unexpected changes in data format, incomplete data, incorrect data, and missing data, among others in the document data 106b.

In some embodiments, the evaluation device 140 may implement machine learning image diffusion model 150 to detect anomalies in the document data 106. For example, the evaluation device 140 may train the image diffusion model 150 on historical document data, where at least some of the historical document data is known to be processed as excepted without failure. By training the image diffusion model 150 on the historical document data, the image diffusion model 150 may learn to identify patterns and progressions of the non-anomalous document processing. In response, if the image diffusion model 150 detects any deviation from the learned patterns of non-anomalous data processing in the document data 106b, the evaluation device 140 (e.g., via the image diffusion model 150) may determine that the document data 106b is anomalous. The evaluation device 140 may implement various embodiments for anomaly detection on any of the document data 106a-n along the network path for the document 104.

### Addressing the Anomalous Document Data

In response to determining that the document data 106b is anomalous, the evaluation device 140 may trigger a recovery protocol 234 to recover the last known safe (non-anomalous) state of the document data 106 and re-execute the API request message 214b to perform the processing operation 124b that initially failed. To this end, the evaluation device 140 may identify the last checkpoint/stage where the document data 106 was found to be non-anomalous, in the checkpoint identification operation 236. In this process, the evaluation device 140 may determine the most recent checkpoint where the document data 106 was verified to be non-anomalous. For example, the evaluation device 140 may analyze the stored document data 106 and associated indexes 108 to identify the stage where the document processing operation 124 was performed without any error, for example, based on the document processing logs.

The evaluation device 140 may extract the API request message 214b details for performing the processing operation 124b in the API detail extraction operation 238. In this process, the evaluation device 140 may extract information such as the specific API endpoint, parameters passed in the API request message 214b, the instruction to perform the processing operation 124b, the headers, and any other relevant metadata required to re-execute the processing operation 124b. The evaluation device 140 may use this information to construct a new API request message 214b.

In some embodiments, the evaluation device 140 may continue the document processing along the network path of the document 104 at the computing device 120b where the processing operation 124b failed. In this process, the evaluation device 140 may re-execute the API request message 214b so that the processing operation 124b is performed on the document 104 and/or preceding document data 106a. In some embodiments, the evaluation device 140 may generate the API request message 214b and communicate the API request message 214b to the computing device 120b. In response, the API request message 214b may be performed via the software application 122b.

In some embodiments, the evaluation device 140 may use the information used in the original API request message 214b to construct the new API request message 214b. In some embodiments, the evaluation device 140 may revise certain information of the API request message 214b so that it may address the specific issues that led to the anomaly. For example, the evaluation device 140 may adjust parameters, update headers, or modify the content to correct errors. The evaluation device 140 may perform similar operations for each document data 106a-b. In some embodiments, the evaluation device 140 may determine whether particular document data 106a-c is anomalous at a respective computing device 102a-c along the network path of the document 104, where the network path of the document 104 may include a set of hops 112a-n between the computing devices 120a-n.

### Method for Detecting and Mitigating Document Anomaly Detection Along a Network Path

FIG. 3 illustrates an example flowchart of a method 300 for detecting and mitigating document anomaly detection along a network path, according to some embodiments. Modifications, additions, or omissions may be made to method 300. Method 300 may include more, fewer, or other operations. For example, operations may be performed in parallel or in any suitable order. While at times, it is described that the system 100, evaluation device 140, or components of any thereof perform some operations, any suitable system or components of the system may perform one or more operations of the method 300. For example, one or more operations of method 300 may be implemented, at least in part, in the form of software instructions 148 of FIG. 1, stored on a tangible non-transitory machine-readable medium (e.g., memory 146 of FIG. 1) that, when run by one or more processors (e.g., processor 142 of FIG. 1), may cause the one or more processors to perform operations 302-322.

At operation 302, the evaluation device 140 receives a first document data 106a from a first computing device 120a, where the first document data 106a is generated based on a first processing operation 124a on the document 104, similar to that described in FIGS. 1-2.

At operation 304, the evaluation device 140 generates a first image 132a for the first document data 106a, the first image 132a uniquely identifies the first document data 106a, similar to that described in FIGS. 1-2.

At operation 306, the evaluation device 140 encrypts the first image 132a with a first noise filter 152. For example, the evaluation device 140 may infuse the first noise pattern 222a into the first image 132a by the noise filter 152, similar to that described in FIGS. 1-2.

At operation 308, the evaluation device 140 stores the encrypted first image 132a in the database 130. At operation 310, the evaluation device 140 receives a second document data 106b from a second computing device 120b, where the second document data 106b is generated based on a second processing operation 124b on the document 104, similar to that described in FIGS. 1-2.

At operation 312, the evaluation device 140 determines whether the second document data 106b is anomalous. Example embodiments for anomaly detection are described in FIGS. 1-2. If it is determined that the second document data 106b is anomalous, the method 300 proceeds to operation 314. Otherwise, the method 300 proceeds to operation 316.

At operation 314, the evaluation device 140 may perform the second processing operation 124b on the document 104, similar to that described in FIGS. 1-2.

At operation 316, the evaluation device 140 generates a second image 132b for the second document data 106b, the second image 132b uniquely identifying the second document data 106b.

At operation 318, the evaluation device 140 encrypts the second image 132b with a second noise filter 152, similar to that described in FIGS. 1-2. At operation 320, the evaluation device 140 stores the encrypted second image 132b in the database 130.

At operation 322, the evaluation device 140 determines whether the document 104 has reached its end of the network path. For example, evaluation device 140 may determine whether the document 104 is processed according to preconfigured criteria or conditions that indicate the completion of its processing. If it is determined that the evaluation device 140 has reached its end of the network path, the method 300 ends. Otherwise, the evaluation device 140 may return on operation 310 to evaluate the next document data 106c, similar to that described in FIG. 2.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. §112(f), as it exists on the date of filing hereof, unless the words “means for” or “step for” are explicitly used in the particular claim.

1. A system comprising:
a memory configured to store a document; and
a processor, operably coupled to the memory, and configured to:
receive first document data from a first computing device, wherein the first document data is generated based at least in part upon a first processing operation on the document at the first computing device;
generate a first image for the first document data, wherein the first image uniquely identifies the first document data;
encrypt the first image with a first noise filter, wherein the first noise filter acts as a first encryption key for the first image;
store the encrypted first image in a database;
receive second document data from a second computing device, wherein the second document data is generated based at least in part upon a second processing operation on the document at a second computing device;
determine that the second document data is anomalous, wherein determining that the second document data is anomalous comprises determining that the second processing operation failed to complete; and
in response to determining that the second document data is anomalous, perform the second processing operation on the document.

2. The system of claim 1, wherein:
the processor is further configured to determine whether particular document data is anomalous at a respective computing device along a network path of the document; and
the network path of the document comprises a plurality of hops between computing devices, the plurality of hops comprises a first hop from the first computing device to the second computing device.

3. The system of claim 1, wherein the processor is further configured to:
generate a second image for the second document data, wherein the second image uniquely identifies the second document data;
encrypt the second image with a second noise filter, wherein the second noise filter acts as a second encryption key for the second image; and
store the encrypted second image in the database.

4. The system of claim 3, wherein encrypting the second image with the second noise filter comprises performing a noise-inducing operation on the second image, wherein performing the noise-inducing operation on the second image comprises changing pixel values associated with the second image according to a preconfigured noise pattern.

5. The system of claim 3, wherein determining that the second document data is anomalous further comprises:
decrypting the encrypted first image by removing a first noise pattern from the first image;
identifying the first document data based at least in part upon the decrypted first image;
decrypting the encrypted second image by removing a second noise pattern from the second image;
identifying the second document data based at least in part upon the decrypted second image;
comparing the first document data with the second document data; and
determining that the second document data is missing certain data that is present in the first document data.

6. The system of claim 1, where encrypting the first image with the first noise filter comprises performing a noise-inducing operation on the first image, wherein performing the noise-inducing operation on the first image comprises changing pixel values associated with the first image according to a preconfigured noise pattern.

7. The system of claim 1, wherein determining that the second document data is anomalous is in response to determining that the second document data is missing an expected data.

8. A method comprising:
receiving first document data from a first computing device, wherein the first document data is generated based at least in part upon a first processing operation on a document at the first computing device;
generating a first image for the first document data, wherein the first image uniquely identifies the first document data;
encrypting the first image with a first noise filter, wherein the first noise filter acts as a first encryption key for the first image;
storing the encrypted first image in a database;
receiving second document data from a second computing device, wherein the second document data is generated based at least in part upon a second processing operation on the document at a second computing device;
determining that the second document data is anomalous, wherein determining that the second document data is anomalous comprises determining that the second processing operation failed to complete; and
in response to determining that the second document data is anomalous, performing the second processing operation on the document.

9. The method of claim 8, wherein:
the method further comprises determining whether particular document data is anomalous at a respective computing device along a network path of the document; and
the network path of the document comprises a plurality of hops between computing devices, the plurality of hops comprises a first hop from the first computing device to the second computing device.

10. The method of claim 8, further comprising:
generating a second image for the second document data, wherein the second image uniquely identifies the second document data;
encrypting the second image with a second noise filter, wherein the second noise filter acts as a second encryption key for the second image; and
storing the encrypted second image in the database.

11. The method of claim 10, wherein encrypting the second image with the second noise filter comprises performing a noise-inducing operation on the second image, wherein performing the noise-inducing operation on the second image comprises changing pixel values associated with the second image according to a preconfigured noise pattern.

12. The method of claim 10, wherein determining that the second document data is anomalous further comprises:
decrypting the encrypted first image by removing a first noise pattern from the first image;
identifying the first document data based at least in part upon the decrypted first image;
decrypting the encrypted second image by removing a second noise pattern from the second image;
identifying the second document data based at least in part upon the decrypted second image;
comparing the first document data with the second document data; and
determining that the second document data is missing certain data that is present in the first document data.

13. The method of claim 8, where encrypting the first image with the first noise filter comprises performing a noise-inducing operation on the first image, wherein performing the noise-inducing operation on the first image comprises changing pixel values associated with the first image according to a preconfigured noise pattern.

14. The method of claim 8, wherein determining that the second document data is anomalous is in response to determining that the second document data is missing an expected data.

15. A non-transitory computer-readable medium storing instructions that, when executed by a processor, cause the processor to:
receive first document data from a first computing device, wherein the first document data is generated based at least in part upon a first processing operation on a document at the first computing device;
generate a first image for the first document data, wherein the first image uniquely identifies the first document data;
encrypt the first image with a first noise filter, wherein the first noise filter acts as a first encryption key for the first image;
store the encrypted first image in a database;
receive second document data from a second computing device, wherein the second document data is generated based at least in part upon a second processing operation on the document at a second computing device;
determine that the second document data is anomalous, wherein determining that the second document data is anomalous comprises determining that the second processing operation failed to complete; and
in response to determining that the second document data is anomalous, perform the second processing operation on the document.

16. The non-transitory computer-readable medium of claim 15, wherein:
the instructions further cause the processor to determine whether particular document data is anomalous at a respective computing device along a network path of the document; and
the network path of the document comprises a plurality of hops between computing devices, the plurality of hops comprises a first hop from the first computing device to the second computing device.

17. The non-transitory computer-readable medium of claim 15, wherein the instructions further cause the processor to:
generate a second image for the second document data, wherein the second image uniquely identifies the second document data;
encrypt the second image with a second noise filter, wherein the second noise filter acts as a second encryption key for the second image; and
store the encrypted second image in the database.

18. The non-transitory computer-readable medium of claim 17, wherein encrypting the second image with the second noise filter comprises performing a noise-inducing operation on the second image, wherein performing the noise-inducing operation on the second image comprises changing pixel values associated with the second image according to a preconfigured noise pattern.

19. The non-transitory computer-readable medium of claim 17, wherein determining that the second document data is anomalous further comprises:
decrypting the encrypted first image by removing a first noise pattern from the first image;
identifying the first document data based at least in part upon the decrypted first image;
decrypting the encrypted second image by removing a second noise pattern from the second image;
identifying the second document data based at least in part upon the decrypted second image;
comparing the first document data with the second document data; and
determining that the second document data is missing certain data that is present in the first document data.

20. The non-transitory computer-readable medium of claim 15, where encrypting the first image with the first noise filter comprises performing a noise-inducing operation on the first image, wherein performing the noise-inducing operation on the first image comprises changing pixel values associated with the first image according to a preconfigured noise pattern.
